(19) United States
(12) Patent Application Publication
(10) Pub. No.: US 2011/0143314 A1
(43) Pub. Date: Jun. 16, 2011

(54) DENTAL DEVICE

(76) Inventor: Sean C.D. Maissami, Hinsdale, IL (US)

(21) Appl. No.: 12/639,683

(22) Filed: Dec. 16, 2009

(51) Int. Cl. A61C 17/00; A46B 9/04

(52) U.S. Cl. 433/147; 15/167.1

(57) ABSTRACT

A dental device including a handle and a channel. An applicator positioned within the handle via the channel, the channel including ribs and bulges that secure the applicator into a number of different positions and/or lengths.

### BACKGROUND OF THE INVENTION

1. Field of the Invention

This invention relates generally to a dental device for application and removal of various materials and solutions to teeth and gums. More specifically, this invention relates to a dental device including a handle and an applicator positionable within the handle via a half-exposed channel, the channel including ribs and bulges that secure the applicator into a number of different positions and/or lengths.

2. Discussion of the Related Art

Handle instruments are generally used in dentistry to facilitate application and removal of various materials and solutions.

Conventional handle instruments can be classified into two categories, single-piece handles and interchangeable handles. Single piece handles are non-adjustable and include an integrally formed applicator. Interchangeable handles include an opening that is designed to accept another piece, generally an applicator tip.

These conventional handle instruments each have various short comings. Single-piece non-adjustable handles are limited to a single type of applicator and cannot vary in length. While conventional interchangeable handles are limited to the design of their exclusive accessories. Conventional interchangeable handles have a fixed indentation that accepts an applicator to a set position and depth that cannot be altered, limiting the usefulness of the handle.

In view of the above statements, there is a need for a dental device which can accept standard applicator tips in various positions, allowing for length adjustments providing greater accessibility and ease of use for a dentist.

### SUMMARY OF THE INVENTION

The present invention provides a dental device that accepts a variety of applicators and allows for length adjustments.

According to one embodiment of this invention, the dental device includes an elongated handle, an opening extending into a channel in the elongated handle. Formed into a wall of the channel is at least one of a rib and/or a bulge. In a preferred embodiment, the rib comprises a pair of ribs that each extend in a plane from opposing walls of the channel. The bulge comprises at least two bulges that extend from opposing walls in an alternating staggered pattern. Preferably, the pair of ribs are positioned closer to the opening than the bulges.

An applicator can be positioned within the channel in a friction fit with at least one of the opening, the wall, the rib, the bulge and/or the channel. The applicator includes a body and a tip portion. The body is preferably a cylindrical body but can be any shape that can fit within the channel and form the friction fit. The tip portion can be of any shape necessary for a dental procedure but generally includes a tapered portion and a point that is frocked with bristles.

To use the handle, a dentist inserts an appropriate applicator for a dental procedure in the channel. The dentist inserts the applicator to an appropriate depth for the procedure while the ribs and bulges securely hold the applicator at this appropriate depth.

Other objects and advantages of this invention are apparent to those skilled in the art, in view of the following detailed description taken in conjunction with the appended claims and drawings.

### BRIEF DESCRIPTION OF THE DRAWINGS

FIG. 1 is a side view of a dental tool, according to one embodiment of this invention;

FIG. 2 is a top view of the dental tool shown in FIG. 1;

FIG. 3 is a side view of the dental tool shown in FIG. 1 with an applicator;

FIG. 4 is a side view of the dental tool shown in FIG. 1 with a second applicator; and

FIG. 5 is a side view of the dental tool shown in FIG. 1 with a third applicator.

### DETAILED DESCRIPTION OF THE INVENTION

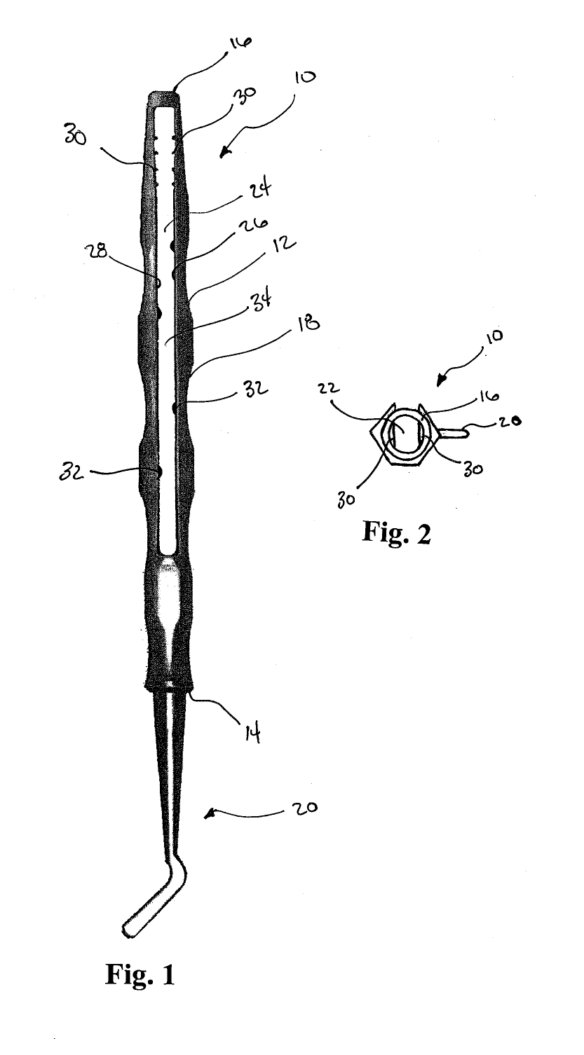

Referring to FIGS. 1-5, the present invention provides dental device 10 that includes elongated handle 12, elongated handle 12 including first end 14 and an opposite second end 16. Elongated handle 12 preferably includes contoured grip 18. Dental device 10 is preferably formed in a unitary molded body, for instance, with an injection molded plastic construction. Dental device 10 may be formed of any other suitable material that is generally flexible, sterile, non-toxic and/or preferably inexpensive so as to promote disposability. Dental device 10 is preferably formed of a material that can be autoclaved and reused multiple times.

Dental tool 20 can be connected to elongated handle 12 at first end 14. Dental tool 20 is preferably formed with elongated handle 12 into a unitary molded body. Dental tool 20 may include a proximate end connects with first end 14 and a tapered portion to a distal end. At the distal end, dental tool 20 may include an instrument useful for a dental procedure including for example, but not limited to, a pick, a scrapper, a spatula, a mirror, a probe and a hook.

Opening 22 is formed in second end 16 and extends coaxial with elongated handle 12 to form channel 24. Channel 24 can be of any shape including, but not limited to, a cylinder or a square-shaped channel. In a preferred embodiment, channel 24 includes first wall 26 and second wall 28. First wall 26 and second wall 28 are generally opposing sides of channel 24. First wall 26 and second wall 28 can have well defined areas, such as opposing sides of a square-shaped channel. Alternatively, first wall 26 and second wall 28 can have less well defined areas, such as opposing arcs of a cylindrically-shaped channel.

Rib 30 can be formed on first wall 26 and/or second wall 28. Rib 30 is generally flat and rectangular shaped extending generally at a right angle to first wall 26 and/or second wall 28. Alternatively, rib 30 can be of any shape and/or extend at any angle from the first wall 26 and/or second wall 28 in order to form a friction fit with applicator 40. In one embodiment, first wall 26 and second wall 28 include a plurality of ribs 30. In a preferred embodiment, a first rib extends from first wall 26 and a second rib extends from second wall 28 and the first rib is co-planar with the second rib. In the embodiment of FIGS. 1-5, four ribs extend from each of first wall 26 and second wall 28 such that each rib is positioned in a plane with another rib on the opposing wall 26, 28.

Bulge 32 can be formed on first wall 26 and/or second wall 28. In one embodiment, first wall 26 and second wall 28 include a plurality of bulges 32. Bulge 32 is a section of a cylinder with a curved section of the cylinder extending from one of first wall 26 or second wall 28. Alternatively, bulge 32 can be of any shape in order to form a friction fit with applicator 40. In a preferred embodiment, a first bulge extends from first wall 26 and a second bulge extends from second wall 28. The first bulge offset from the second bulge. In the embodiment of FIG. 1, dental tool 20 includes four bulges 32, two bulges 32 on each wall, in an alternating staggered pattern.

Generally, rib 30 is smaller in size relative to bulge 32 and rib 30 is positioned closer to second end 16 than bulge 32. Alternatively, rib 30 can be larger than bulge 32 and/or bulge 32 could be positioned closer to second end 16 than rib 30.

In the embodiment of FIGS. 1-5, channel 24 is exposed along a portion of a length of handle 12 forming slot 34. Slot 34 provides a view of the position of applicator 40 within channel 24. Slot 34 also eases the placement of applicator 40 into channel 24 by allowing air pressure to be released. Without slot 34 the friction fit of applicator 40 could prevent air from escaping out of opening 22, hindering placement of applicator 40. Alternatively, dental device 10 can be designed without slot 34.

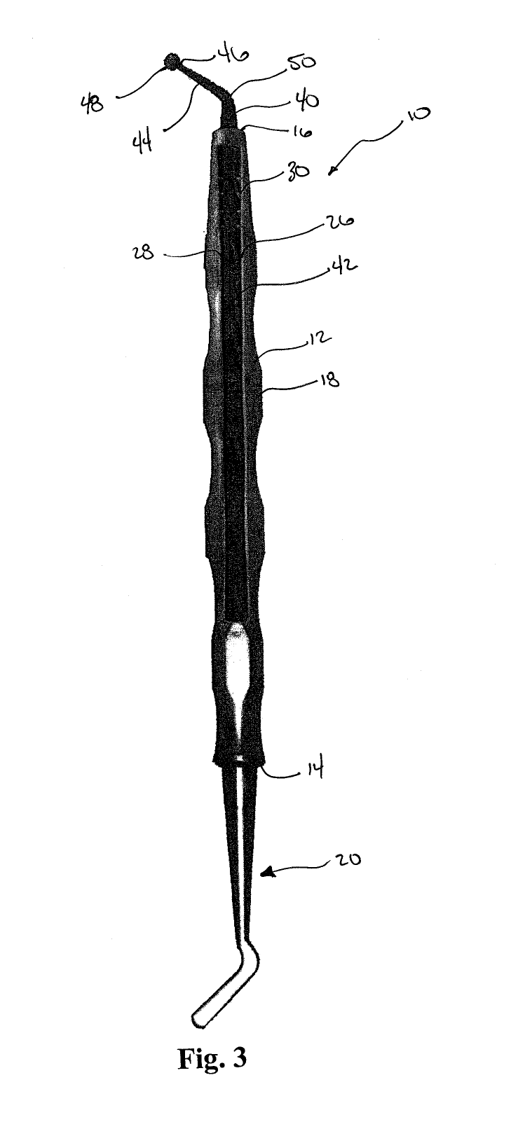

Dental device 10 of this invention accepts applicator 40 in opening 22 and into channel 24. In general, applicators are used to apply a dental composition to a tooth surface or region. Applicator 40 includes body 42 that fits into opening 22 and channel 24 and forms a friction fit with at least one of opening 22, first wall 26, second wall 28, rib 30 and/or bulge 32. In FIG. 3, body 42 consists of a cylindrical shape. However, body 42 could be of any shape including, but not limited to, a square or a triangular shape that can form a friction fit as described above.

In the embodiment of FIG. 3, applicator 40 includes tip portion 44, which tapers from body 42 to point 46. Tip portion 44 is preferably frocked with a plurality of bristles 48. Preferably, applicator 40 is pliable to permit tip portion 20 to be bent in a desired position or configuration as necessary for various dental procedures.

In one preferred embodiment of this invention, at least one weakened portion 50 can be formed in applicator 40 and located within an area of tip portion 20. According to a preferred embodiment of this invention, weakened portion 50 comprises a reduced a diameter shoulder. Alternatively, weakened portion 50 may comprise some other structure or treatment to applicator 40 that permits tip portion 44 to be bent in a desired position or configuration.

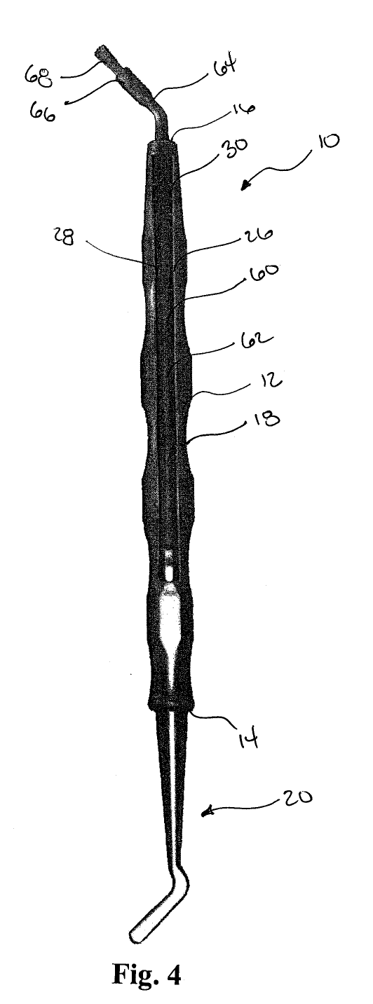

In the embodiment of FIG. 4, applicator 60 includes tip portion 64, connected to body 62, tip portion 64 further including brush head 66 and bristles 68. Preferably, applicator 60 is pliable to permit tip portion 64 to be bent in a desired position or configuration as necessary for various dental procedures, tip portion 64 can also include a weakened portion to ease bending of applicator 60.

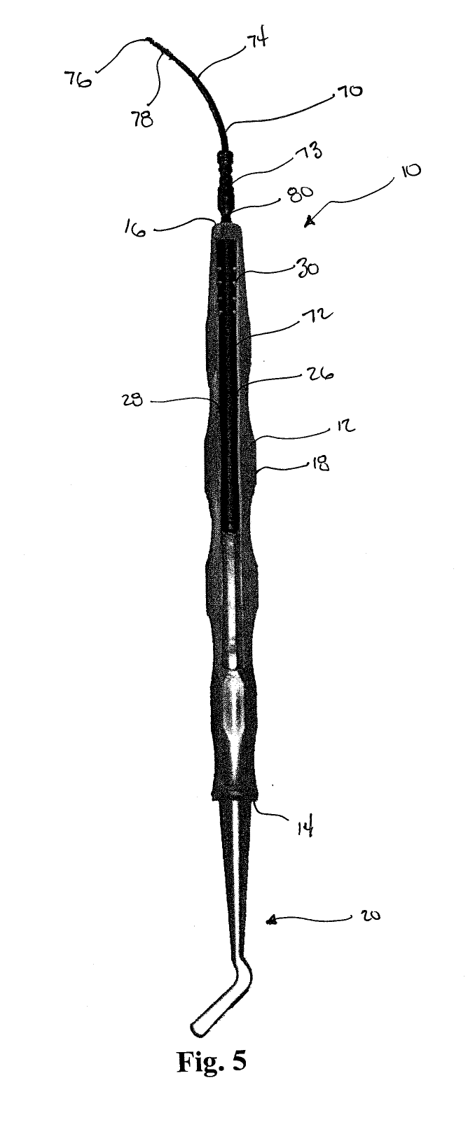

In the embodiment of FIG. 5, applicator 70 can comprise a device as taught by U.S. patent application Ser. No. 12/181,148, filed on 27 Jul. 2007. U.S. patent application Ser. No. 12/181,148 is hereby incorporated by reference herein in its entirety and is made a part hereof, including but not limited to those portions which specifically appear hereinafter. Applicator 70 includes body 72 and access handle 73 that is preferably formed at a distal end of body 72. Access handle includes tip portion 74 preferably tapers to point 76. Tip portion 76 is further preferably flocked with a plurality of bristles 78.

According to one preferred embodiment of this invention, tip portion 76 is freely pliable into a desired configuration.

In one preferred embodiment of this invention, at least one weakened portion 80 can be formed in access handle 73. Weakened portion 80 permits a user to bend or to snap off access handle 73 from body 72. Weakened portion 80 preferably comprises a reduced diameter shoulder formed between body 72 and access handle 73. Weakened portion 80 may alternatively comprise some other structure or treatment to applicator 70 that permits a clean break between body 72 and access handle 73.

The invention illustratively disclosed herein suitably may be practiced in the absence of any element, part, step, component, or ingredient which is not specifically disclosed herein.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

What is claimed is:

1. A dental device comprising:
an elongated handle comprising a first end and an opposite second end, the elongated handle including a contoured grip;
a dental tool formed at the first end;
an opening formed in the second end and extending coaxially with the elongated handle to form a channel, the channel including a first wall and a second wall;
a rib extending from at least one of the first wall and the second wall; and
a bulge extending from at least one of the first wall and the second wall.

2. The dental device of claim 1, wherein the elongated handle and the dental tool comprise a unitary molded body.

3. The dental device of claim 1 comprising a pair of ribs generally extending at a right angle from each of the first wall and the second wall of the channel.

4. The dental device of claim 1 further comprising a plurality of bulges extending from each of the first wall and the second wall in a staggered pattern.

5. The dental device of claim 1 wherein the channel is exposed along a length of the handle.

6. The dental device of claim 1 further comprising an applicator, wherein the opening accepts the applicator.

7. The dental device of claim 6, wherein the applicator comprises a cylindrical body that forms a friction fit with at least one of the opening, the first wall, the second wall, the rib and the bulge.

8. The dental device of claim 7 wherein the applicator includes a brush head.

9. The dental device of claim 7 wherein the applicator tapers to a point flocked with a plurality of bristles.

10. The dental device of claim 7 wherein the applicator includes a weakened portion, the applicator pliable into a desired configuration at the weakened portion.

11. The dental device of claim 7 wherein the applicator includes a shaft and an access handle, the access handle formed along the shaft;
a plurality of circumferential ribs formed at a proximate end of the access handle;
a tip portion formed at a distal end of the access handle, the tip portion tapering to a point flocked with a plurality of bristles; and
a reduced diameter shoulder formed between the shaft and the access handle, the access handle separable from the shaft along the reduced diameter shoulder.

12. A dental device comprising:
an elongated handle including a contoured grip;
an opening formed in an end of the elongated handle and extending coaxially with the elongated handle to form a channel, the channel forming a slot extending along a length of the elongated handle and the channel including a first wall and a second wall;
a first rib extending from of the first wall and a second rib extending from the second wall, each of the first rib and the second rib positioned in a plane;
a bulge extending from at least one of the first wall and the second wall; and
an applicator positioned at least partially within the channel, the applicator comprising a cylindrical body friction fit with at least one of the opening, the first wall, the second wall, the first rib, the second rib and the bulge.

13. The dental device of claim 12, wherein the elongated handle and the dental tool comprise a unitary molded body.

14. The dental device of claim 12 wherein the bulge comprises a plurality of bulges extending alternately from the first wall and the second wall of the channel.

15. The dental device of claim 12 wherein the applicator includes a brush head.

16. The dental device of claim 12 wherein the applicator tapers to a point flocked with a plurality of bristles.

17. The dental device of claim 16 wherein the applicator includes a weakened portion, the applicator pliable into a desired configuration at the weakened portion.

18. The dental device of claim 12 wherein the applicator includes a shaft, an access handle, the access handle formed along the shaft;
a plurality of circumferential ribs formed at a proximate end of the access handle;
a tip portion formed at a distal end of the access handle, the tip portion tapering to a point flocked with a plurality of bristles; and
a reduced diameter shoulder formed between the shaft and the access handle, the access handle separable from the shaft along the reduced diameter shoulder.
